(19) United States
(12) Patent Application Publication
(10) Pub. No.: US 2015/0045280 A1
(43) Pub. Date: Feb. 12, 2015

(54) FLOOR CLEANING FORMULATION COMPRISING AN AGENT FOR CONTROLLING INSECTS

(71) Applicant: Alexander Landesberg, Herzeliya (IL)

(72) Inventor: Alexander Landesberg, Herzeliya (IL)

(73) Assignee: SANO BRUNO'S ENTERPRISES LTD., Hod Hasharon (IL)

(21) Appl. No.: 14/358,746

(22) PCT Filed: Nov. 17, 2011
(86) PCT No.: PCT/IL2011/000890

§ 371 Date: Oct. 28, 2014

(51) Int. Cl. C11D 3/00; C11D 3/32

(52) U.S. Cl. CPC C11D 3/0005; C11D 3/323
USPC 510/387; 510/108; 510/493

(57) ABSTRACT

The present invention is directed to a cleaning formulation comprising a cleaning agent and an insect growth regulator (IGR) and to a method for indoor control of household insects comprising applying a cleaning formulation comprising a cleaning agent and an insect growth regulator (IGR).

### FIELD OF THE INVENTION

This invention relates to an improved floor cleaning formulation containing an additional active component for controlling insects.

### BACKGROUND OF THE INVENTION

Household cleaning formulations are primarily intended to maintain a clean environment, although cleaning formulations further containing additives for controlling undesired insects, bacteria and other pathogens were also developed. EP 525,892 is directed to aqueous liquid detergent compositions for cleaning hard surfaces, which contain an insect repellent material such as those within the class of N-alkyl neoalkanamides wherein the alkyl is of 1 to 4 carbon atoms and the neoalkanoyl moiety is of 7 to 14 carbon atoms. EP 677,579 describes a cleaning composition for hard surfaces which have the capacity to clean as well as repel insects from the hard surface to which they are applied. The effect is achieved by N-lower alkyl neoalkanamides. The cleaning composition disclosed in EP 677,579 is a microemulsion for cleaning kitchen walls, oven top, bathroom floor or the like while at the same time applying a film of insect repellent material which is sufficiently substantive to the surface to which the composition is applied to repel insects therefrom.

WO 04/035723 discloses a cleaning composition comprising antimicrobial agent used for both cleaning surfaces and disinfecting. The composition may further comprise one or more insect repellant agents.

Growth regulators are widely known in commercial pesticidal compositions mainly used outdoors. There exist several household compositions, mainly in the form of spays for controlling insects which contain growth regulators. EP 784,428 discloses such a composition for denaturating the antigens of house dust mites and their excrement. The composition which is optionally in the form of a spray contains glutaraldehyde as the active agent where the composition may further contain a growth regulator. U.S. Pat. No. 5,612,047 discloses microemulsions containing insect growth regulators. U.S. Pat. No. 6,750,256 discloses a formulation for controlling ants using α-hexyl cinnamic aldehyde.

### SUMMARY OF THE INVENTION

The present invention is based on the fact that it has been found that a commercial cleaning composition further comprising an insect growth regulator yields a prolonged effect in controlling household insects.

Thus the invention is directed to a cleaning formulation comprising a cleaning agent and an insect growth regulator (IGR). The cleaning formulation may further comprise in addition to the cleaning agent and the IGR, a fragrance, a preservative, emulsifier, solubilizer, a foaming booster, a colorant, light stabilizers or dyes which are all dissolvable in water. Preferably the cleaning formulation is a water-based formulation and is intended for hard surfaces.

Thus the present invention is directed to a cleaning formulation comprising:
(i) a cleaning agent; and
(ii) (ii) an insect growth regulator (IGR).

The present invention is further directed to cleaning formulation comprising:
(i) from about 2 to about 5 wt % cleaning agent selected from anionic, cationic or non-ionic surfactant;
(ii) from about 0.5 to about 2 wt % alkyl ether sulphate (C₁₀-C₁₄, 1-3 ethoxylations), known as ETA 70;
(iii) from about 0.001 to about 0.1 wt % insect growth regulator;
(iv) from about 0.3 to about 2 wt % fragrance; and
(v) from about 0.01 to about 1 wt % stabilizer; and
(vi) water up to 100 wt %;
and optionally dyes, colorants, light stabilizers enhancers.

The invention is further directed to a method of controlling household insects, by applying a cleaning formulation containing a cleaning agent and an insect growth regulator to surfaces in the house, preferably to hard surfaces such as tiles, ceramics, doors, windows, window frames, plates, boards, walls and the like. The cleaning formulation used comprises:
(i) a cleaning agent; and
(ii) an insect growth regulator (IGR).

The invention is yet further directed to a method of controlling household insects, by applying a cleaning formulation containing a cleaning agent and an insect growth regulator to surfaces in the house, preferably to hard surfaces such as tiles, ceramics, doors, windows, window frames, plates, boards, walls and the like. The cleaning formulation used comprises:
(i) from about 2 to about 5 wt % cleaning agent selected from non-ionic surfactant;
(ii) from about 0.5 to about 2 wt % alkyl ether sulphate (C₁₀-C₁₄, 1-3 ethoxylations), known as ETA 70;
(iii) from about 0.001 to about 0.1 wt % insect growth regulator;
(iv) from about 0.3 to about 2 wt % fragrance; and
(v) from about 0.01 to about 1 wt % stabilizer; and
(vi) water up to 100 wt %.

### DETAILED DESCRIPTION OF THE INVENTION

As mentioned the present invention is directed to a cleaning formulation comprising in addition to the cleaning agent at least one insect growth regulator (IGR). Using the cleaning formulation of the present invention for routine cleaning yields a beneficial additional effect of an efficient control of insects up to 40 days from the application of the cleaning formulation to the surface it was applied on. Therefore, frequent use of the cleaning formulation results in a clean area as well as in an efficient control of common household insects and is an efficient substitute to spraying areas against household insects. The cleaning formulation is preferably an aqueous based cleaning formulation which can further be diluted in water. The cleaning formulation basically comprises a cleaning agent and the IGR.

IGR, contrary to classic insecticides (synthetic chemical insecticides), do not affect an insect's nervous system and are preferable for use within closed environments, the area cleaning formulations are used and applied. Another advantage is in the fact that, while insects can become resistant to insecticides, they are less likely to become resistant to IGR. Hence frequent application of the cleaning formulation of the present invention should result in an area where insects have developed resistance to its presence requiring higher and higher concentrations of the IGR in order to achieve the beneficial result.

The IGR present in the cleaning formulation of the invention may be any IGR affecting and controlling the growth of insects, affecting its hormone system. These may be chosen from juvenile hormone mimic category such as hydroprene and methoprene, from chitin synthesis inhibitors such as hexaflumuron, lufenuron and diflubenzuron.

According to another embodiment, the IGR belong to the family of benzoylurea. In particular, the IGRs which may be employed by the present invention are chosen from the group consisting of chlorfluazuron, diflubenzuron, fluazuron, flucycloxuron, flufenoxuron, lufenuron, novaluron, teflubenzuron and triflumuron. Preferably the IGR is novaluron, lufenuron or their mixture, most preferably it is novaluron. Novaluron (U.S. Pat. No. 4,980,376) and lufenuron (U.S. Pat. No. 4,798,837) are known as (±)-1-[3-chloro-4-(1,1,2-trifluoro-2-trifluoromethoxy-ethoxy)ethoxy)-phenyl]-3-(2,6-di-fluoro-benzoyl)urea and (RS)-1-[2,5-dichloro-4-(1,1,2,3,3,3-hexafluoropropoxy)phenyl]-3-(2,6-difluorobenzo-yl)-urea, respectively.

The cleaning agent in the formulation may be a cationic, anionic or non-ionic surfactant. Preferably the cleaning agent is a non-ionic surfactant. The cleaning formulation of the present invention may further comprise, in addition to the cleaning agent and the IGR, a fragrance, an emulsifier, a solubilizer, a foaming booster, a preservative, a colorant, light stabilizers or dyes which are all dissolvable in water. Non limiting examples of preservative material are formaldehyde, isothiazoline derivatives, chloracetamide, glutaraldehyde, 2-bromo-2-nitropropane 1,3-diol. Preferably, the improved cleaning composition according to the present invention is intended for cleaning hard surfaces. Hard surfaces are tiles, ceramics, windows, window's frames, plates, boards, walls or doors.

Preferably, the cleaning formulation comprises: (i) from about 2 to about 5 wt % non-ionic surfactant; (ii) from about 0.5 to about 2 wt % alkyl ether sulphate (C₁₀-C₁₄, 1-3 ethoxylations), known as ETA 70; (iii) from about 0.001 to about 0.1 wt % insect growth regulator; (iv) from about 0.3 to about 2 wt % fragrance; (v) from about 0.01 to about 1 wt % stabilizer; and (vi) water up to 100 wt %. It should be noted that a known commercial cleaning formulation (Ritzpaz Plus®) comprises the above-mentioned components, excluding the IGR, where the non-ionic surfactant is nonylphenyl ether (NP-10) and the preservative is a formaldehyde 37% solution.

Comparing the action of the known commercial cleaning formulation with the improved cleaning formulation of the present invention comprising the insect growth regulator applied to hard surfaces such as tiles and ceramics showed an improved control of common house-hold insects upon routine use of the improved cleaning formulation. In particular, cockroaches and ants were exterminated on the surfaces where the improved cleaning formulation was applied. In order to achieve good control of the insects, the cleaning formulation should be used on a routine basis. Depending on the concentration of the IGR in the cleaning formulation and its nature, the formulation may be used once a week or once every two weeks. At a dilution of 1:20 of the above-mentioned formulation containing novaluron as the IGR, larva of Blatella germanica exposed to tiles or ceramics cleaned with the improved cleaning formulation of the present invention were efficiently exterminated. Adult cockroaches were however, not affected at the dilution of 1:20 of the above-mentioned formulation and developed normally. In particular, during a 40 days period, the adult cockroaches exposed to the area treated with the cleaning formulation were not affected and further laid new larva which developed normally. At lower dilution rates such as 1:5 or 1:10 adult cockroaches are expected to be exterminated as well. The efficacy of control on the larva varied as a function of the type of flower (normal tile vs. ceramic tiles) and further as a function of the number of times the surface was treated. The results are summarized in Example 2 (Tables II-IV). Turning to Table II, cockroaches larva exposed to ceramic tiles right after they were treated with the formulation of the present invention were exterminated. 50% death was achieved 8 days after exposure and 60% death was achieved after 12 days. On the other hand, cockroaches larva exposed to regular tiles right after they were treated with the formulation of the present invention were exterminated. 50% death was achieved 6 days after exposure and 90% death was achieved after 12 days of exposure. 15 days after exposure 94% of the larvas were dead.

Turning to Table III, cockroaches larva exposed to regular tiles right after they were treated with the formulation of the present invention were exterminated. The tiles were treated twice with the cleaning formulation of the present invention with a period of 20 days between the two treatments. 50% death was achieved 5 days after exposure and 96% death was achieved after 12 days of exposure. 15 days after exposure 98% of the larvas were dead.

Turning to Table IV, cockroaches larva exposed to regular tiles treated with the formulation of the present invention were exterminated. The tiles were treated twice with the cleaning formulation of the present invention with a period of 20 days between the two treatments and the exposure of the larva to the tiles was done 21 days after the second treatment of the tiles. 50% death was achieved 8 days after exposure and 64% death was achieved after 10 days of exposure. Larva which were not effected maintained their normal development and produced cockroaches.

### EXAMPLES

### General

Formulations: The formulation of the present invention (invention formulation) comprises (wt) 93% water, 4% NP-10, 1% ETA-70®, 0.3% Novaluron 10% solution, 1.2% perfume (e.g. peach blossom), 0.2% formaldehyde 37% solution and colorant. The control formulation comprises (wt) 93% water, 4% NP-10, 1% ETA-70®, 1.2% peach blossom, 0.2% formaldehyde 37% solution and colorant. The formulations were diluted in water at various ratios prior to their use. A thin layer of the diluted formulation was applied twice using a sponge (10 minutes between the two applications) to regular or ceramic tiles (20×20 cm). The treated tile (regular or ceramic) was inserted into a plastic container (40×60 cm) whose upper sides were covered with a thin layer of Teflon® or Vaseline® to prevent escape of insects. Each box is equipped with food and water.
Insects: German cockroaches (Blatella germanica) were used. The tests used initial larval stage, young and adult cockroaches. The population used was grown in the laboratory which was further enriched several times during the year by wild type cockroaches.
Adult cockroaches—into each box were introduced 10 female and 5 male cockroaches. The “adults” are cockroaches after their last larva period, however, are relatively young cockroaches. Each day, larva which were developed from the cockroaches and new cockroaches which developed from larva were collected to determine the percentage of larva hatching and the amount of cockroaches produced by the females.
Larva cockroaches—25 larva at their initial larva stage were introduced into each box. Initial larva stage means several days after hatching. Dead larvas were taken out each day and the development of the live larva was monitored.
Humidity was kept at 60% throughout the tests and the temperature was kept in the range of 27-30° C.

### Example 1

The efficacy of the invention formulation on the control of adult cockroaches was checked. Into each plastic container containing the tiles covered with a thin layer of the tested formulation (invention formulation; control formulation—Ritzpaz Plus®; and control—tiles coated only with water) 10 female and 5 male cockroaches were introduced. The results are given in Table I were each treatment was done three times where in each time two parallel boxes were prepared (6 times altogether).

TABLE I
The amount of new larva (and further developed cockroaches).

Type

| of | | Days | | | | | | | | | | |
|---|---|---|---|---|---|---|---|---|---|---|---|---|
| floor | Formulation | 28 | 29 | 30 | 31 | 32 | 33 | 34 | 35 | 36 | 36 | 38 |
| Tile | Invention | 1 | 1 | 1 | 2 | 2 | 0 | 1 | 0 | 1 | 0 | 1 |
| | Formulation | | | | | | | | | | | |
| Tile | Control | 0 | 2 | 1 | 1 | 0 | 2 | 0 | 2 | 1 | 0 | 1 |
| | Formulation | | | | | | | | | | | |
| Tile | Control | 1 | 0 | 2 | 0 | 1 | 1 | 3 | 1 | 0 | 1 | |

The cockroaches exposed were not affected during 40 days, laid new larva where all new developed cockroaches were normal and further developed into normal cockroaches.

### Example 2

The efficacy of the invention formulation on the control of cockroaches larva in their initial stage was checked for its effect. The effect was measured right after a single treatment (Table II), right after two consecutive treatments 20 days between the two treatments (Table III) and 21 days after two consecutive treatments 20 days between the two treatments (Table IV). Into each plastic container containing the tiles covered with a thin layer of the tested formulation (invention formulation; control formulation—Ritzpaz Plus®; and control—tiles coated only with water) 25 cockroaches larva in their initial stage were introduced. The results given in Tables II, III and IV displaying the percentage of dead larva were done three times where in each time two parallel boxes were prepared (6 times altogether).

TABLE II
Checking the effect right after a single treatment.

Type

| of | | Days | | | | | | | |
|---|---|---|---|---|---|---|---|---|---|
| floor | Formulation | 3 | 4 | 6 | 8 | 10 | 12 | 15 | 18 |
| Ceramic Tile | Invention | 4 | 14 | 34 | 52 | 58 | 60 | 60 | 60 |
| | Formulation | | | | | | | | |
| Ceramic Tile | Control | 0 | 0 | 0 | 4 | 7 | 8 | 8 | 11 |
| | Formulation | | | | | | | | |
| Ceramic Tile | Control | 0 | 0 | 0 | 3 | 5 | 5 | 8 | 8 |
| Normal Tile | Invention | 6 | 30 | 48 | 82 | 86 | 90 | 94 | 94 |
| | Formulation | | | | | | | | |
| Normal Tile | Control | 0 | 0 | 0 | 1 | 3 | 4 | 7 | 8 |
| | Formulation | | | | | | | | |
| Normal Tile | Control | 3 | 3 | 3 | 3 | 4 | 8 | 8 | 8 |

TABLE III
Checking right after two consecutive treatments
(20 days gap between the two treatments).

Type

| of | | Days | | | | | | | |
|---|---|---|---|---|---|---|---|---|---|
| floor | Formulation | 3 | 4 | 6 | 8 | 10 | 12 | 15 | 18 |
| Normal Tile | Invention | 6 | 18 | 88 | 92 | 94 | 96 | 98 | 98 |
| | Formulation | | | | | | | | |
| Normal Tile | Control Form | 4 | 8 | 12 | 12 | 12 | 12 | 12 | 12 |
| Normal Tile | Control | 3 | 7 | 7 | 8 | 8 | 8 | 9 | 9 |

TABLE IV
Checking 21 days after two consecutive treatments
(20 days gap between the two treatments).

Type

| of | | Days | | | | | | | |
|---|---|---|---|---|---|---|---|---|---|
| floor | Formulation | 3 | 4 | 6 | 8 | 10 | 12 | 15 | 18 |
| Normal Tile | Invention | 1 | 2 | 6 | 56 | 64 | 64 | 64 | 64 |
| | Formulation | | | | | | | | |
| Normal Tile | Control Form | 0 | 1 | 3 | 4 | 7 | 8 | 8 | 8 |
| Normal Tile | Control | 1 | 3 | 4 | 8 | 11 | 12 | 13 | 15 |

### Example 3

The efficacy of insect control of diluted formulations where the invention formulation was diluted in water was done by using the following diluted formulations: 1:100; 1:200; 1:300; and 1:1000. The control formulation (Ritzpaz Plus®) was diluted at 1:100. The results are given in Table V. The experiments were done as described above where the appropriate formulation was applied twice to the tiles and the tiles then placed in an appropriate box. 25 larvas of German Cockroaches (at their initial stage of development—several days after hatching) were placed in each such box and the dead cockroaches were counted. Three series of experiments were carried out wherein in each series 9 boxes were tested (2 for each of the invention formulation dilution and one for the control formulation).

TABLE V
Tested Dosage

| Days from the | | | | | |
|---|---|---|---|---|---|
| beginning | 1:100 | 1:200 | 1:300 | 1:1000 | Inspection |
| 4 | 0 | 0 | 0 | 0 | 0 |
| 5 | 8 | 5 | 0 | 0 | 0 |
| 6 | 15 | 10 | 5 | 0 | 0 |
| 7 | 20 | 15 | 10 | 0 | 0 |
| 8 | 40 | 35 | 20 | 5 | 0 |
| 9 | 60 | 50 | 30 | 7 | 0 |
| 10 | 90 | 70 | 40 | 10 | 0 |
| 12 | 100 | 90 | 60 | 15 | 0 |
| 14 | — | 100 | 90 | 20 | 0 |
| 16 | — | — | 100 | 20 | 0 |
| 20 | — | — | — | 22 | 0 |

The effect varies as a function of dilution (concentration). At dilutions of 1:100 and 1:200 the larva begin to die after 5 days where throughout the period the larva did not develop. Full death (100%) was achieved after 12 and 14 days, respectively. At a dilution of 1:300 the larva began to die after 6 days and full death was achieved 16 days after the beginning of the exposure (100%). During the experiment some of the larva did develop prior to their death. At a dilution of 1:1000 the larva began to die only 8 days after exposure and their death was stopped after about 14 days. At this dilution, most of the larva developed and matured as adult cockroaches.

In order to further verify the effect of the formulation of the invention, the formulation of the present invention (Examples—general) was tested in two comparative experiments for the efficiency of controlling cockroaches in a kitchen. In each experiment, 20 larva of Blatella germanica (4 weeks after hatching) were introduced into a plastic cell (23 cm×23 cm×20 cm) with a hole for ventilation and a closed gate through which food and water are introduced. The plastic cell placed at an upper part of the kitchen, not on the floor) was equipped with heating means such that the temperature was 2-4° C. above its surroundings. The larva was allowed to grow in the plastic cell for 4 weeks before opening the gate. Parallel to each experiment, a similar cell having larva as a control (different dimensions of 35 cm×40 cm×65 cm) was also used. At the end of each experiment the number of cockroaches collected in the kitchen was compare to the number of cockroaches in the control cell. In the first experiment (Experiment I) conducted for 18 weeks, food was distributed initially only in the upper part of the kitchen (cupboards sinks, etc.) and only after 4 weeks also on the floor. After a waiting period of 4 weeks a second experiment was conducted for 10 weeks. In the second (Experiment II) food was evenly distributed from the beginning in the upper part of the kitchen as well as on the floor. The floor was regularly washed with the formulation of the invention every 3-4 days (diluted 1:20 as explained above). The results of the two experiments are summarized in Table VI:

| | Experiment I | Experiment II |
|---|---|---|
| Number of initial | 20 larva, 4 weeks from | 20 larva, 4 weeks from |
| cockroaches in the | hatching | hatching |
| experiment and in control | | |
| Duration of experiment | 18 weeks (after 4 weeks | 10 weeks (after 4 weeks of |
| (time of actual | of growth) | growth) |
| investigation | | |
| Number of cockroaches at | 700 ± 50 adult | 300 ± 20 adult |
| the end of the period | 1,200 ± 100 larva; | 250 ± 30 intermediate larva |
| Control | Altogether: 1,900 ± 50 | 500 ± 50 small larva (up to |
| | | 2 mm) |
| | | Altogether: 1,050 ± 100 |
| Number of cockroaches at | 89 adult; 25 mediate | 11 adult; 18 intermediate; 5 |
| the end (around the | larva; 121 small larva; | small; |
| kitchen) of each experiment | Altogether: 235 | Altogether 34. |
| Ratio of cockroaches at the | ≈12% | ≈3.5% |
| end of the experiment | | |
| compared to those in the | | |
| control cell | | |

In experiment I during the 22 weeks (18+4) the population grew ≈12 fold, however, was only ≈12% of the population at the control. In experiment II during the 14 weeks (10+4), the population grew only very limited (≈2) and was only ≈3.5% of the population at the control. Apparently, attracting cockroaches to the floor by placing food on the floor and washing the floor every 4 days resulted in a significant decrease in the number of cockroaches.

1. A water-based cleaning formulation for cleaning hard surfaces, comprising a cleaning agent and an insect growth regulator (IGR).

2. (canceled)

3. A formulation according to claim 1 wherein the cleaning agent is an anionic, cationic or non-ionic surfactant.

4. A formulation according to claim 1, wherein said IGR is one or more of the group consisting of chlorfluazuron, diflubenzuron, fluazuron, flucycloxuron, flufenoxuron, flufenoxuron, lufenuron, novaluron, teflubenzuron or triflumuron.

5. A formulation according to claim 1 further comprising a fragrance, an emulsifier, a solubilizer, a foaming booster, a preservative, a colorant, light stabilizers or dyes which are all dissolvable in water.

6. A formulation according to claim 1 comprising:
(i) 2 to 5 wt % non-ionic surfactant;
(ii) 0.5 to 2 wt % alkyl ether sulphate (C₁₀-C₁₄, 1 to 3 ethoxylations); (ETA 70®);
(iii) 0.001 to 0.1 wt % insect growth regulator;
(iv) 0.3 to 2 wt % fragrance;
(v) 0.01 to 1 wt % formaldehyde 37% solution;
(v) water up to 100 wt %;

7. A formulation according to claim 6 wherein the non-ionic surfactant is nonylphenyl ether (NP-10).

8. A formulation according to claim 6, wherein said formulation is diluted in water from 1:100 up to 1:300, preferably up to 1:200 and most preferably 1:100.

9. A method of indoor control of household insects comprising applying a water-based cleaning formulation comprising a cleaning agent and an insect growth regulator (IGR).

10. A method according to claim 9 wherein said formulation is intended for cleaning of hard surfaces.

11. A method according to claim 9 wherein the cleaning agent is an anionic, cationic or non-ionic surfactant.

12. A method according to claim 9, wherein said IGR is chosen from the group of benzoylurea growth regulators consisting of chlorfluazuron, diflubenzuron, fluazuron, flucycloxuron, flufenoxuron, lufenuron, novaluron, teflubenzuron or triflumuron.

13. A method according to claim 9 wherein said cleaning formulation further comprises a fragrance, an emulsifier, a solubilizer, a foaming booster, a preservative, a colorant, light stabilizers or dyes which are all dissolvable in water.

14. A method according to claim 9 wherein said cleaning formulation comprises:
(i) 2 to 5 wt % non-ionic surfactant;
(ii) 0.5 to 2 wt % alkyl ether sulphate (C₁₀-C₁₄, 1 to 3 ethoxylations); (ETA 70(D);
(in) 0.001 to 0.1 wt % insect growth regulator;
(iv) 0.3 to 2 wt % fragrance;
(v) 0.01 to 1 wt % formaldehyde 37% solution;
(vi) water up to 100 wt %.

15. A method according to claim 14 wherein the non-ionic surfactant is nonylphenyl ether (NP-10).

16. A method according to claim 14, wherein said formulation is diluted in water from 1:100 up to 1:300, preferably up to 1:200 and most preferably 1:100.
